(19) United States
(12) Patent Application Publication
(10) Pub. No.: US 2010/0048335 A1
(43) Pub. Date: Feb. 25, 2010

(54) BELT ASSEMBLY DEVICE PROVIDED WITH A BALL LOCK SYSTEM

(75) Inventor: Fabien Debuire, Cormeilles en Parisis (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES S.A., Velizy Villacoublay (FR)

(21) Appl. No.: 12/517,005

(22) PCT Filed: Nov. 27, 2007
(86) PCT No.: PCT/FR07/52405

§ 371 Date: May 29, 2009

(30) Foreign Application Priority Data
Dec. 1, 2006 (FR) 0655247

(51) Int. Cl. F16H 7/24

(52) U.S. Cl. 474/130

(57) ABSTRACT

An elastic belt assembly device (1) around a pulley (20), comprising mechanic means (2) for driving and slipping the belt toward the pulley (20), the said device (1) being formed by an autonomous part capable of fixing to the pulley (20). The main characteristic of the device according to the invention is that it comprises a hanging means (3) provided with peripheral stoppers (9), capable of being liberated through activation of a control handle (5), allowing the insertion of said system (3) in the pulley (20).

The present invention claims priority of French application 0655247 filed on Dec. 1, 2006, whose content (description, claims and drawings) is incorporated by reference herein.

The technical field of the invention concerns devices for installation of an elastic belt around a pulley, such as, for example, an accessory belt of a motor vehicle engine, which goes around the crankshaft pulley. More particularly, the invention concerns a device for installing an elastic belt around a pulley comprising an attachment system that makes it possible to fix it on said pulley.

Devices for installing an elastic belt around a pulley already exist and they have already been the subject of patents. For example, US patent application 2003/0176248 can be cited, which concerns a device that makes it possible to install an elastic belt around a pulley. The device is first contacted with the pulley around which the belt is intended to be engaged, then it is rotated manually by means of a lever arm integral with said device to engage the belt around said pulley. This patent does not describe any particular means for fixing the installation device on the pulley.

The installation device according to the invention, designed to engage an elastic belt around a pulley, comprises an attachment system making it possible to fix it to said pulley or to remove it from the pulley by an easy and effortless manipulation of a control lever integral with said system. In this way, this attachment system, which does not require the use of any outside tool, allows for an adaptive, easy and quick assembly of the installation device on the pulley. In the case where the pulley would belong to an object intended to be mounted on an assembly line, the speed of implementation of the fixing device would bring about a significant reduction of the installation time of the belt around the pulley, and would contribute to increasing the processing pace for said objects.

An objective of the present invention is a device for installation of a belt around a pulley, comprising mechanical means for guiding and sliding the belt toward the pulley, said device being constituted by an autonomous part adapted to be fixed on said pulley. The main characteristic of the device according to the invention is that it comprises an attachment system provided with peripheral stops, adapted to be released under the effect of actuation of a control lever, in order to allow insertion of said system into the pulley. That is, in rest position, the stops are blocked and they protrude from the attachment system, thus increasing its outline, which prevents insertion of said system in the pulley. By actuating the lever, the stops are released and the system can then be inserted in the location of the pulley designed for this purpose. The term “released” applied to the stops means that they are no longer blocked and they can retract into the system under the effect of an external pressure.

Advantageously, the lever is integral with the attachment system and it can be moved by sliding along its longitudinal axis, from an equilibrium position. That is, the operator takes the installation device and, before inserting it in the pulley, pulls the lever toward him to release the stops. Preferably, the attachment system has internal means making it possible to maintain the lever in a rest position, in which the stops are protruding. The expressions “rest position” and “equilibrium position” are equivalent.

Preferably, the attachment system is equipped with return means making it possible for the lever to return to its equilibrium position, said action having the effect of making the stops protrude from the outline of the attachment system. In this way, the operator, after he has introduced the attachment system in the pulley, can release the lever, which, under the action of the return means, returns to its equilibrium position, thus making the stops protrude. Said stops, which are extended inside the pulley, then block the installation device against said pulley, and prevent it from being pulled back. By pulling the lever again, he can unlock the attachment system in order to detach the installation device from the pulley.

Advantageously, the return means are constituted by a spring.

Advantageously, the control lever comprises a cylindrical body having, at one of its extremities, an enlarged head making it possible to manipulate said lever, and at its other extremity, an enlarged frusto-conical tip.

Preferably, the stops are constituted by balls, each of which is located at the extremity of a channel in which is placed a transmission part having an elongated shape, said channels being located in a same transverse plane and disposed in radial position relative to the longitudinal axis of the lever, the lever and said channels being arranged so that each transmission part is in contact both with a ball and with the enlarged frusto-conical tip of said lever. When an external force is applied to a ball which protrudes from the system, a pull on the lever displaces in particular its enlarged frusto-conical tip, which, thanks to its slope, makes it possible for each group formed by the ball and the transmission part to retract into the attachment system. This force can, for example, be caused by the wall of the recess of the pulley designed to receive said system, at the time of its insertion into said pulley. Advantageously, the transmission parts are constituted by cylindric rods whose length is more than that of the channels in which they are housed.

Preferably, each channel ends with an enlarged portion in which the ball is housed, said enlarged portion having a distal restriction whose width is smaller than the diameter of the ball. Thus, in rest position, each transmission part bears against the enlarged tip and tends to push the ball back against said restriction. The ball is thus trapped in the enlarged portion, while being allowed to protrude from said portion.

Advantageously, the attachment system has three balls located at the extremity of three channels distributed regularly about a circle and forming with each other 120° angles. This arrangement corresponds to a satisfactory compromise between a good stability of the system's attachment in the pulley and a simplified geometry using a small number of balls.

Preferably, the attachment system comprises three lobes adapted to be inserted into recesses of the pulley, a respective radial channel having a ball at its extremity passing through each of said lobes. In other words, the attachment system is attached to the pulley via three attachment points, and when the lever is pulled, the balls are retracted at the time of their contact with the wall of the recesses.

Advantageously, the balls and transmission parts are made of steel.

The installation device according to the invention has the advantage that it is autonomous, and that it can be manipulated instantaneously, without using outside tools. In addition, due to the small size of the control lever and the small amplitude of its displacement, the attachment system of the installation device according to the invention has a highly ergonomic design.

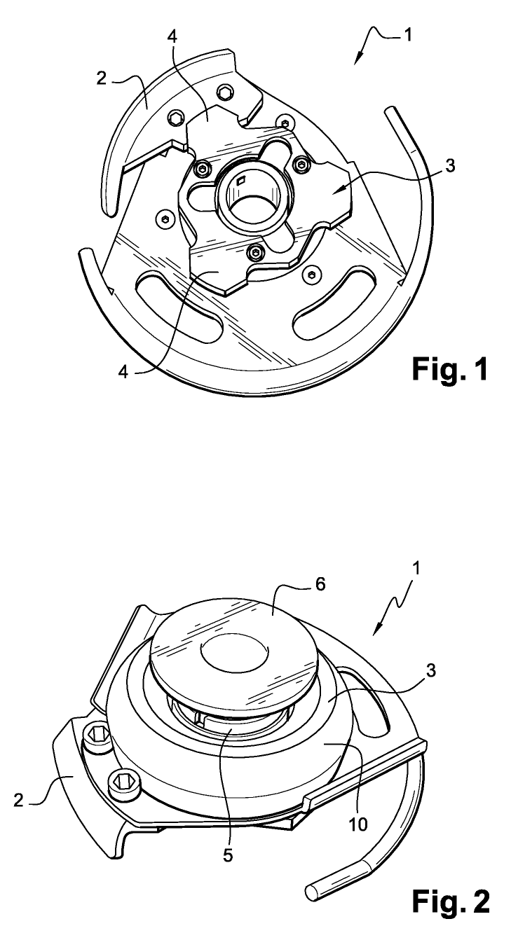

A detailed description of a preferred embodiment of an installation device according to the invention is provided below, by reference to FIGS. 1 to 9.

FIG. 1 is a frontal view of an installation device according to the invention.

FIG. 2 is a perspective view of the device of FIG. 1 showing its rear face.

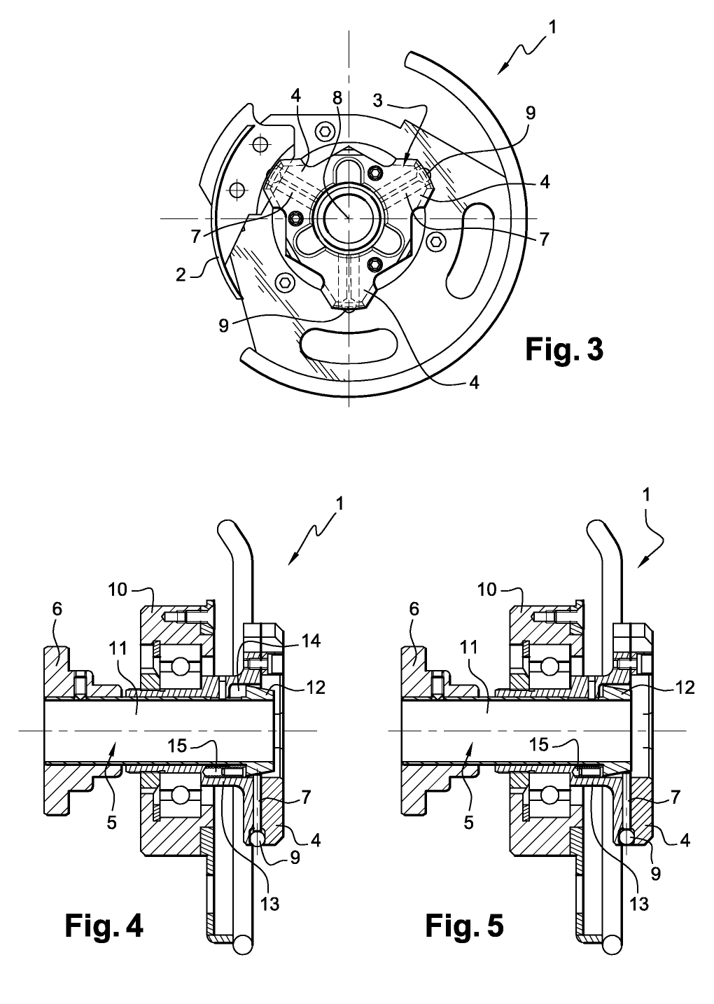

FIG. 3 is a transversal cross-sectional view of the installation device according to the invention, which shows in details, notably, its attachment system to the pulley.

FIG. 4 is a longitudinal cross-sectional view of an installation device according to the invention, in rest position.

FIG. 5 is a view of the device of FIG. 4, in operation.

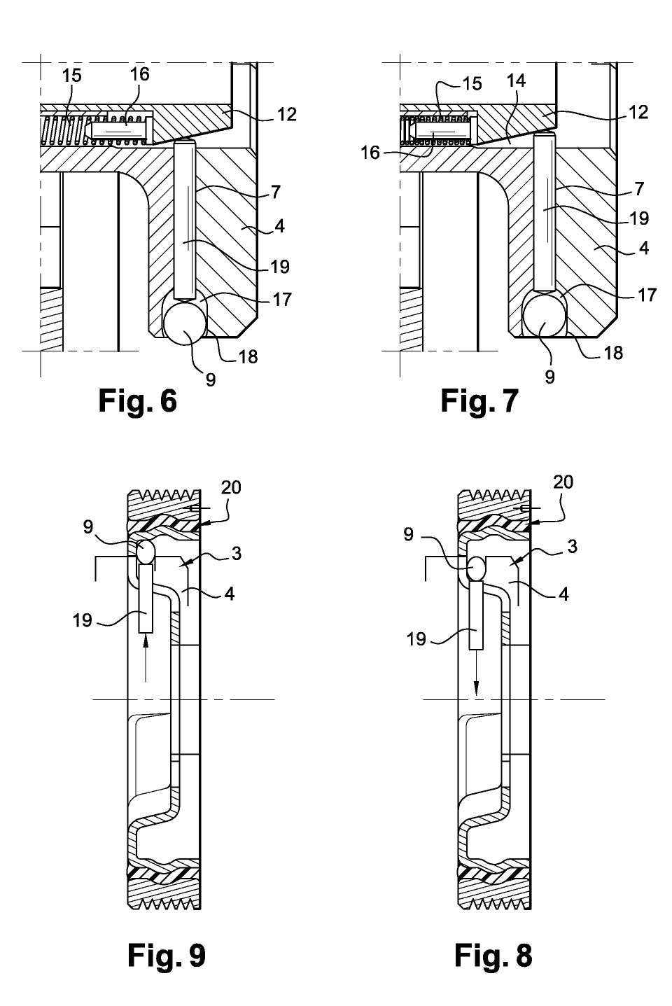

FIG. 6 is an enlarged longitudinal cross-sectional view of a portion of the installation device according to the invention, in rest position.

FIG. 7 is an enlarged longitudinal cross-sectional view of a portion of the installation device according to the invention, in operation.

FIG. 8 is a schematic view of the interaction between the installation device according to the invention and the pulley, when the stops are released.

FIG. 9 is a schematic view of the interaction between the installation device according to the invention and the pulley, when the stops are blocked.

Referring to FIGS. 1 and 2, an installation device 1 according to the invention comprises conventional guiding and sliding mechanical means 2, as well as an attachment system 3 allowing said device to be fixed to a pulley (20), around which an elastic belt is intended to be installed (the belt and the pulley are not shown on the Figures). The guiding and sliding mechanical means 2 can be materialized, for example, by a curved sliding surface 2, associated with a retaining ramp for the belt and a stop having a profiled cross-section, making it possible to reduce progressively the width of said path. By rotating said mechanical means 2, the belt, initially placed on the path, will slide laterally in a progressive manner to move away from it laterally and be transferred around the pulley 20. The attachment system 3 is in a substantially central position in the installation device 1, and it has an internal portion comprising fixation organs for fixing it to the pulley, and an external portion directly accessible by the operator and comprising the manipulation organs of said system 3.

Referring to FIG. 1 which shows the internal portion of the attachment system 3, said system 3 has in particular three lobes 4 regularly distributed around a circle, and thus forming with each other 120° angles. These lobes 4 constitute fixation organs of the attachment system 3 to the pulley 20, these lobes 4 being adapted to be inserted into the pulley 20.

Referring to FIG. 2 which shows the external portion of the attachment system 3, the manipulation organs of said system 3 are constituted by a control lever 5, which has an enlarged head 6 allowing an operator to manipulate said lever 5 easily. The attachment system 3 also has an intermediary holding part 10 that allows making it integral with the guiding and sliding mechanical means 2.

Referring to FIG. 3 which shows a transversal cross-section plane of the internal portion of the attachment system 3, a respective channel 7 located in radial position relative to the longitudinal axis 8 of the control lever 5 passes through each of the lobes 4. These channels 7 are disposed in a same transversal plane relative to said longitudinal axis 8, and thus, they form with each other 120° angles. Each of said channels 7 has a free end that houses a ball 9.

Referring to FIGS. 4 and 5, a control lever 5 passes through an installation device 1 according to the invention, this control lever 5 having a cylindrical body 11, an extremity of which is composed of the enlarged head 6 which protrudes from said system 1, and whose other extremity ends with an enlarged frusto-conical tip 12. The intermediate holding part 10 extends with a cylindrical portion 13 having a smaller diameter and the same longitudinal axis, said portion 13 supporting the three fixation lobes 4. A central channel designed to receive the body 11 of the lever 5 is formed through the intermediary part 10 and the reduced diameter portion 13, said channel ending with an enlarged portion 14 located inside the reduce diameter portion. This enlarged portion 14 forms a chamber in which the enlarged frusto-conical tip 12 of the body 11 of the lever 5 is positioned. A preloaded spring 15, whose longitudinal axis is parallel to the longitudinal axis of the body 11, comes to bear both against an internal shoulder of the central channel and against the shoulder formed on said body 11 by the enlarged tip 12. As shown on FIG. 4, this spring has the effect of maintaining the enlarged tip 12 away from the bottom of the chamber 14. Referring to FIG. 5, when the operator pulls the lever 5 to make the body 11 of said lever 5 slide in the central channel, it moves the enlarged tip until it contacts the bottom of the chamber 14, which compresses a little more the spring 15. When the operator releases the head 6 of the lever 5, the compressed spring 15 is released and extends again to bring said lever 5 back to a stable equilibrium position. The channels 7 passing through the lobes 4 and ending with a ball 9 connect the chamber 14, in which the enlarged tip 12 of the lever 5 is positioned, and the outside of said lobes 4.

Referring to FIGS. 6 and 7, the enlarged tip 12 has an elongated guiding lug 16, around which the spring 15 is wound. The longitudinal axis of the lug 16 is parallel to the longitudinal axis of the body 11 of the lever 5, said lug 16 being formed in the area of the shoulder created by the enlarged tip 12 on said body 11. Each of the channels 7 that pass through the lobes 4 is cylindrical and has, in the area of its extremity that opens outside of said lobe 4, an enlarged portion 17 in which the ball 9 is housed. The cylindrical portion of each of said channels 7 houses a transmission part 19 assimilated to a cylindrical rod, whose length is more than the length of the cylindrical portion of the channel 7 in which it is housed. The enlarged portion 17 has a distal restriction 18 whose diameter is less than that of the ball 9. Referring to FIG. 6, when the attachment system 3 is in rest position, all these elements are arranged so that each rod 19 protrudes both in the chamber 14 and in the enlarged portion 17 of the channel 7 in which it is housed, and comes to bear, firstly, against the enlarged tip 12 of the body 11 of the lever 5, and secondly, against the ball 9, which is pushed against the restriction 18 of said enlarged portion 17. In this blocking configuration, the balls 9 protrude from the enlarged portions 17 in which they are housed, and make it possible to increase the outline of the attachment system 3. Referring to FIG. 7, when the operator slides the control lever 5, thus compressing the spring 15 a little more, the enlarged tip 12 moves longitudinally in the chamber 14, which makes it possible, thanks to its slope, to move the rod 19 radially toward the center of said chamber 14, thus releasing the ball 9 into the enlarged portion 17.

Referring to FIGS. 8 and 9, the mode of operation of an installation device 1 according to the invention is performed according to the following steps.

The operator brings the installation device 1 equipped with its attachment system 3 in the vicinity of the pulley 20 around which he wants to install the belt. He takes the head 6 of the control lever 5, and then causes said lever to slide by applying a pulling force sufficient to compress the spring 15 a little more. The rods 19 move toward the inside of the chamber 14, as shown by the arrow, thus releasing the balls 9. The external outline of the attachment system 3 is reduced, as it is only made up by that of the lobes 4. Said system 3 can then be inserted into recesses of the pulley 20 designed to receive the lobes 4. Referring to FIG. 9, once the system 3 has been inserted into the pulley 20, the operator releases the pressure on the control lever 5, which, under the effect of the spring 15, slides back to return to its equilibrium position, which makes the balls 9 protrude inside said pulley 20. The assembly device is fixed to the pulley 20. The operator then places the belt around said assembly device 1, and using an external tool serving as lever arm, performs a rotation of the device 1 to allow the elastic belt to be transferred around the pulley 20. Once the operation is completed, the operator pulls again on the control lever 5 to release the balls 9, and thus withdraw the installation device 1 from the pulley 20.

1. Device for installation of an elastic belt around a pulley, comprising mechanical means for guiding and sliding the belt toward the pulley, said device being constituted by an autonomous part adapted to be fixed on said pulley and comprising an attachment system provided with peripheral stops, adapted to be released under the effect of actuation of a control lever, in order to allow insertion of said system into the pulley, wherein the lever is integral with the attachment system and can be moved by sliding along its longitudinal axis, from an equilibrium position.

2. Device according to claim 1, wherein the attachment system is equipped with return means making it possible for the lever to return to its equilibrium position, said action having the effect of making the stops protrude from the outline of the attachment system.

3. Device according to claim 2, wherein the return means are constituted by a spring.

4. Device according to claim 1, wherein the control lever comprises a cylindrical body having, at one of its extremities, an enlarged head making it possible to manipulate said lever, and at its other extremity, an enlarged frusto-conical tip.

5. Device according to claim 4, wherein the stops are constituted by balls, each of which is located at the extremity of a channel in which is placed a transmission part having an elongated shape, said channels being located in a same transverse plane and disposed in radial position relative to the longitudinal axis of the lever, the lever and said channels being arranged so that each transmission part is in contact both with a ball and with the enlarged frusto-conical tip of said lever.

6. Device according to claim 5, wherein each channel ends with an enlarged portion in which the ball is housed, said enlarged portion having a distal restriction whose width is smaller than the diameter of the ball.

7. Device according to claim 5, wherein the attachment system has three balls located at the extremity of three channels distributed regularly about a circle and forming with each other 120° angles.

8. Device according to claim 7, wherein the attachment system comprises three lobes adapted to be inserted in recesses of the pulley, a respective radial channel having a ball at its extremity passing through each of said lobes.

9. Device according to claim 5, wherein the balls and transmission parts are made of steel.

10. Device according to claim 2, wherein the control lever comprises a cylindrical body having, at one of its extremities, an enlarged head making it possible to manipulate said lever, and at its other extremity, an enlarged frusto-conical tip.

11. Device according to claim 10, wherein the stops are constituted by balls, each of which is located at the extremity of a channel in which is placed a transmission part having an elongated shape, said channels being located in a same transverse plane and disposed in radial position relative to the longitudinal axis of the lever, the lever and said channels being arranged so that each transmission part is in contact both with a ball and with the enlarged frusto-conical tip of said lever.

12. Device according to claim 11, wherein each channel ends with an enlarged portion in which the ball is housed, said enlarged portion having a distal restriction whose width is smaller than the diameter of the ball.

13. Device according to claim 3, wherein the control lever comprises a cylindrical body having, at one of its extremities, an enlarged head making it possible to manipulate said lever, and at its other extremity, an enlarged frusto-conical tip.

14. Device according to claim 13, wherein the stops are constituted by balls, each of which is located at the extremity of a channel in which is placed a transmission part having an elongated shape, said channels being located in a same transverse plane and disposed in radial position relative to the longitudinal axis of the lever, the lever and said channels being arranged so that each transmission part is in contact both with a ball and with the enlarged frusto-conical tip of said lever.

15. Device according to claim 14, wherein each channel ends with an enlarged portion in which the ball is housed, said enlarged portion having a distal restriction whose width is smaller than the diameter of the ball.

16. Device according to claim 6, wherein the attachment system has three balls located at the extremity of three channels distributed regularly about a circle and forming with each other 120° angles.

17. Device according to claim 16, wherein the attachment system comprises three lobes adapted to be inserted in recesses of the pulley, a respective radial channel having a ball at its extremity passing through each of said lobes.

18. Device according to claim 12, wherein the attachment system has three balls located at the extremity of three channels distributed regularly about a circle and forming with each other 120° angles.

19. Device according to claim 18, wherein the attachment system comprises three lobes adapted to be inserted in recesses of the pulley, a respective radial channel having a ball at its extremity passing through each of said lobes.

20. Device according to claim 13, wherein the attachment system has three balls located at the extremity of three channels distributed regularly about a circle and forming with each other 120° angles.
